(19) United States
(12) Patent Application Publication
(10) Pub. No.: US 2011/0219307 A1
(43) Pub. Date: Sep. 8, 2011

(54) METHOD AND APPARATUS FOR PROVIDING MEDIA MIXING BASED ON USER INTERACTIONS

(75) Inventors: Sujeet Shyamsundar Mate, Tampere (FI); Igor Danilo Diego Curcio, Tampere (FI)

(73) Assignee: Nokia Corporation

(21) Appl. No.: 12/715,578

(22) Filed: Mar. 2, 2010

(51) Int. Cl. G06F 3/048; G06F 15/16; G06F 3/16

(52) U.S. Cl. 715/717; 715/781; 715/738

(57) ABSTRACT

An apparatus for providing media mixing based on user interaction may include at least one processor and at least one memory including computer program code. The at least one memory and the computer program code may be configured to, with the at least one processor, cause the apparatus to perform at least receiving an indication of shared content to be provided to a plurality of group members, receiving social interaction media associated with at least one of the group members, and mixing the shared content with the social interaction media to provide mixed content having audio mixing performed based at least in part on a configuration of the social interaction media relative to the shared content on a display. A corresponding method and computer program product are also provided.

### TECHNOLOGICAL FIELD

Embodiments of the present invention relate generally to content sharing technology and, more particularly, relate to a method and apparatus for providing media mixing based on user interactions.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users by expanding the capabilities of mobile electronic devices. One area in which there is a demand to increase ease of information transfer relates to the sharing of information between multiple devices and potentially between multiple users. In this regard, given the ability for modem electronic devices to create and modify content, and also to distribute or share content, it is not uncommon for users of such devices to become prolific users and producers of media content. Networks and services have been developed to enable users to move created content to various points within the networks or experience content at various points within the networks.

Various applications and software have also been developed and continue to be developed in order to give the users robust capabilities to perform tasks, communicate, obtain information or services, entertain themselves, etc. in either fixed or mobile environments. Given the robust capabilities of mobile electronic devices and the relatively small size of such devices, it is becoming increasingly common for individuals to keep mobile electronic devices on or near their person on a nearly continuous basis. Moreover, because such devices are useful for work, play, leisure, entertainment, and other purposes, many users also interact with their devices on a frequent basis. Accordingly, whether interaction occurs via a mobile electronic device or a fixed electronic device (e.g., a personal computer (PC)), more and more people are interacting with friends, colleagues and acquaintances via online networks. This trend has led to the rise of a number of social networking applications that span the entire spectrum of human interaction from purely professional to purely leisure activities and everything in between.

Users of social networking applications often use the social network as a mechanism by which to distribute content to others. Moreover, the concept of social television (TV) has been developed to enable sets of other users, friends, or colleagues to meet in a virtual shared space and watch TV or other video content while also being able to interact socially. The social interaction aspect often takes the form of some form of communication that is added to or over the video content (e.g., dubbing or subtitles). However, it may be desirable to develop yet further mechanisms by which to enable access to content in a social environment and by which to enhance the experience for users.

### BRIEF SUMMARY

A method, apparatus and computer program product are therefore provided for enabling the provision of media mixing based on user interaction. In this regard, for example, some embodiments of the present invention may provide a mechanism by which user interaction may impact media mixing. In this regard, for example, movements of media windows associated with social interaction media may have changeable configurations and a content mixer may be provided to account for configuration changes of the media window and also synchronize audio spatial changes with the corresponding configuration changes.

In one example embodiment, a method of providing media mixing based on user interaction is provided. The method may include receiving an indication of shared content to be provided to a plurality of group members, receiving social interaction media associated with at least one of the group members, and mixing the shared content with the social interaction media to provide mixed content having audio mixing performed based at least in part on a configuration of the social interaction media relative to the shared content on a display.

In another example embodiment, a computer program product for providing media mixing based on user interaction is provided. The computer program product includes at least one computer-readable storage medium having computer-executable program code instructions stored therein. The computer-executable program code instructions may include program code instructions for receiving an indication of shared content to be provided to a plurality of group members, receiving social interaction media associated with at least one of the group members, and mixing the shared content with the social interaction media to provide mixed content having audio mixing performed based at least in part on a configuration of the social interaction media relative to the shared content on a display.

In another example embodiment, an apparatus for providing media mixing based on user interaction is provided. The apparatus may include at least one processor and at least one memory including computer program code. The at least one memory and the computer program code may be configured to, with the at least one processor, cause the apparatus to perform at least receiving an indication of shared content to be provided to a plurality of group members, receiving social interaction media associated with at least one of the group members, and mixing the shared content with the social interaction media to provide mixed content having audio mixing performed based at least in part on a configuration of the social interaction media relative to the shared content on a display.

Embodiments of the invention may provide a method, apparatus and computer program product for employment in network based content sharing environments. As a result, for example, individual device users may enjoy improved capabilities with respect to sharing content with a selected group of other device users.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a communication system according to an example embodiment of the present invention;

FIG. 2 is a schematic block diagram of an apparatus for providing media mixing based on user interaction according to an example embodiment of the present invention;

FIG. 3 illustrates a sample display view of mixed content according to an example embodiment of the present invention;

FIG. 4 illustrates a sample display view of mixed content showing movement of social interaction media to avoid overlap with a region of interest according to an example embodiment of the present invention;

FIG. 5 illustrates another sample display view of mixed content showing a different configuration change to the social interaction media according to an example embodiment of the present invention;

FIG. 6 illustrates yet another sample display view of mixed content showing a different configuration change to the social interaction media according to an example embodiment of the present invention;

FIG. 7 shows one example structure for a system that may employ media mixing based on user interaction in accordance with example embodiments of the present invention;

FIG. 8 illustrates example protocols that may be employed for control channel and transport stacks and for media session and transport stacks according to an example embodiment of the present invention; and

FIG. 9 is a block diagram according to an example method for providing media mixing based on user interaction according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

Electronic devices have been rapidly developing in relation to their communication and content sharing capabilities. As the capabilities of such devices have increased, applications and services have grown to leverage the capabilities to provide increased utility and improved experience for users. Social networks and various services and functionalities supporting social networks are examples of mechanisms developed to leverage device and network capabilities to provide users with the ability to communicate with each other while experiencing shared content. The shared content may be video and/or audio content that is broadcast from another source or provided by a member of a social network group for consumption by other group members. Meanwhile, while experiencing the shared content together, various group members may discuss the content or other topics by providing text, audio and/or video commentary (e.g., in the form of social interaction media) to be overlaid over the shared content. However, in some cases, the shared content may be obstructed by overlaid video, commentary, images, or other material.

Accordingly, some embodiments of the present invention may provide for a mechanism by which to enable users to move such media to avoid overlaying the social interaction media over important portions of the content being overlaid. However, some embodiments may further provide for the user interactions with the social interaction media to form a basis for media mixing of the shared content with the social interaction media. For example, a position of media windows providing social interaction media may be used as the basis for audio mixing to make the audio rendering reflective of the relative positions of respective media windows with which audio of the shared content is being mixed. Thus, sound associated with a media window on a left side of a display screen may be mixed such that it sounds like the corresponding audio is coming from the user's left side. Furthermore, as a position of the media window is changed, so to the audio mixing may be altered accordingly. Thus, users will be provided with improved capabilities for personalizing and satisfactorily experiencing content in a social environment.

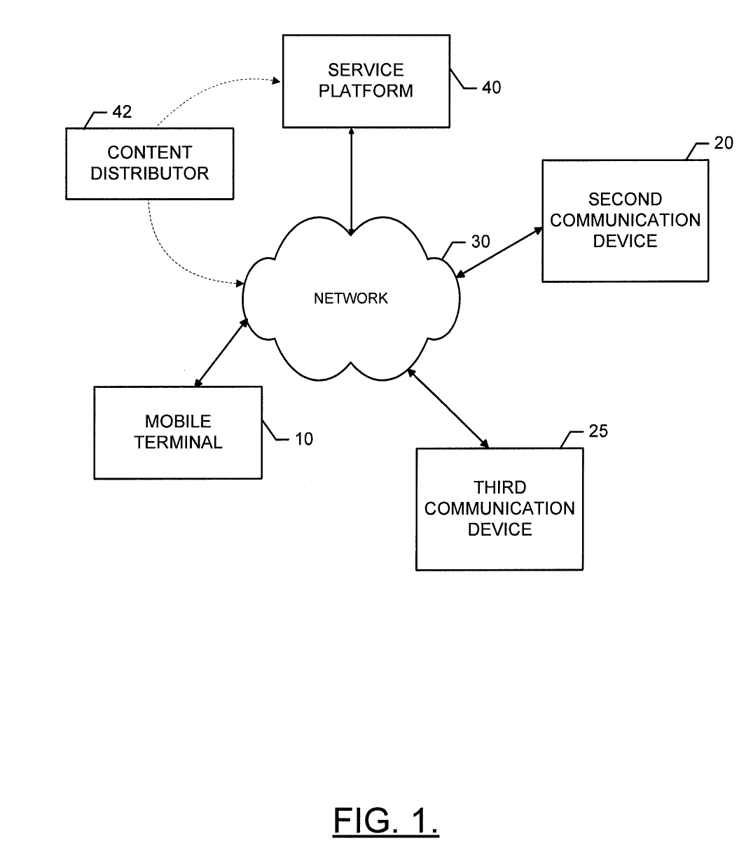

FIG. 1 illustrates a generic system diagram in which a device such as a mobile terminal 10, which may benefit from embodiments of the present invention, is shown in an example communication environment. As shown in FIG. 1, an embodiment of a system in accordance with an example embodiment of the present invention may include a first communication device (e.g., mobile terminal 10) and a second communication device 20 capable of communication with each other via a network 30. In some cases, embodiments of the present invention may further include one or more network devices such as a service platform 40 with which the mobile terminal 10 (and possibly also the second communication device 20) may communicate to provide, request and/or receive information. Furthermore, in some cases, the mobile terminal 10 may be in communication with the second communication device 20 (e.g., a PC or another mobile terminal) and one or more additional communication devices (e.g., third communication device 25), which may also be either mobile or fixed communication devices.

The mobile terminal 10 may be any of multiple types of mobile communication and/or computing devices such as, for example, portable digital assistants (PDAs), pagers, mobile televisions, mobile telephones, gaming devices, laptop computers, cameras, camera phones, video recorders, audio/video player, radio, global positioning system (GPS) devices, or any combination of the aforementioned, and other types of voice and text communications devices. The second and third communication devices 20 and 25 may be any of the above listed mobile communication devices or an example of a fixed communication device such as a PC or other computing device or communication terminal having a relatively fixed location and wired or wireless access to the network 30.

The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like.

One or more communication terminals such as the mobile terminal 10 and the second and third communication devices 20 and 25 may be in communication with each other via the network 30 and each may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. Alternatively, such devices may include communication interfaces supporting landline based or wired communication with the network 30. In turn, other devices such as processing elements (e.g., personal computers, server computers or the like) may be coupled to the mobile terminal 10 and/or the second and third communication devices 20 and 25 via the network 30. By directly or indirectly connecting the mobile terminal 10 and/or the second communication device 20 and other devices to the network 30, the mobile terminal 10 and/or the second and third communication devices 20 and 25 may be enabled to communicate with the other devices or each other, for example, according to numerous communication protocols including Hypertext Transfer Protocol (HTTP) and/or the like, to thereby carry out various communication or other functions of the mobile terminal 10 and the second and third communication devices 20 and 25, respectively.

Furthermore, although not shown in FIG. 1, the mobile terminal 10 and the second and third communication devices 20 and 25 may communicate in accordance with, for example, radio frequency (RF), Bluetooth (BT), Infrared (IR) or any of a number of different wireline or wireless communication techniques, including LAN, wireless LAN (WLAN), Worldwide Interoperability for Microwave Access (WiMAX), WiFi, ultra-wide band (UWB), Wibree techniques and/or the like. As such, the mobile terminal 10 and the second and third communication devices 20 and 25 may be enabled to communicate with the network 30 and each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

In example embodiments, regardless of the form of instantiation of the devices involved, embodiments of the present invention may relate to the provision of access to content within the context of a social network including a defined group of users and/or the devices of the users. The group may be predefined based on any of a number of ways that a particular group may be formed. In this regard, for example, invited members may accept invitations to join the group, applications may be submitted and accepted applicants may become group members, or a group membership manager may define a set of users to be members of a group. Thus, for example, group members could be part of a social network or may be associated with a particular service such as a service hosted by or associated with the service platform 40. Accordingly, it should be appreciated that, although FIG. 1 shows three example devices capable of communication, some embodiments may include groups like social networks with the potential for many more group members and corresponding devices. Thus, FIG. 1 should not be seen as being limiting in this regard.

In an example embodiment, the service platform 40 may be a device or node such as a server or other processing circuitry. The service platform 40 may have any number of functions or associations with various services. As such, for example, the service platform 40 may be a platform such as a dedicated server, backend server, or server bank associated with a particular information source, function or service. Thus, the service platform 40 may represent one or more of a plurality of different services or information sources. The functionality of the service platform 40 may be provided by hardware and/or software components configured to operate in accordance with known techniques for the provision of information to users of communication devices, except as modified as described herein.

In an example embodiment, the service platform 40 may provide, among other things, content management, content sharing, content acquisition and other services related to communication and media content. Nokia's Ovi suite is an example of a service provision mechanism that may be associated with the service platform 40. In some cases, the service platform 40 may include, be associated with, or otherwise be functional in connection with a content distributor 42. However, the content distributor 42 could alternatively be embodied at one or more of the mobile terminal 10 and/or the second and third communication devices 20 and 25, or even at some other device within the network. As such, for example, in some cases the network 30 could be an ad hoc, peer-to-peer (P2P) network in which the content distributor 42 is embodied in at least one of the devices forming the P2P network. Thus, although the content distributor 42 is shown as a separate entity in FIG. 1, it should be appreciated that the content distributor 42 could be associated directly with or even instantiated at any of the other devices shown in FIG. 1 in various alternative embodiments. In any case, as will be discussed in greater detail below, the content distributor 42 according to one example may provide content in the form of television broadcast or other video/audio content for consumption by group members. In some cases, the content may be content originating from a source external to the group, but in other cases, one group member may select content to be shared with other members of the group and provide such content to the other members or have such content streamed from the content distributor 42.

In an example embodiment, the service platform 40 may be associated with the provision of functionality and services associated with social networking. Thus, for example, the service platform 40 may include functionality associated with enabling group members to share social interaction media with each other. As such, the service platform 40 may act as or otherwise include a social TV server or another social networking server for providing the social interaction media to group members based on individual participant media submissions from various ones of the group members. The social interaction media may include text, audio, graphics, images, video and/or the like that may be overlaid over other content being shared among group members (e.g., shared content). Thus, in some cases, such as is sometimes the case with social TV, the social interaction media may be commentary regarding the shared content.

In some cases, the content distributor 42 may provide content to the service platform 40 and the service platform 40 may integrate the content provided thereto by the content distributor 42 with social interaction content provided from the group members (e.g., the mobile terminal 10 and/or the second and third communication devices 20 and 25). The service platform 40 may employ an apparatus for object based media mixing according to an example embodiment to thereafter provide mixed content to the group members. Alternatively, the service platform 40 may provide the social interaction media to the group members and the content distributor 42 may separately provide content for viewing by the group members and the individual devices of the group members may employ an apparatus for media mixing based on user interactions according to an example embodiment to thereafter provide mixed or composite content to the group members.

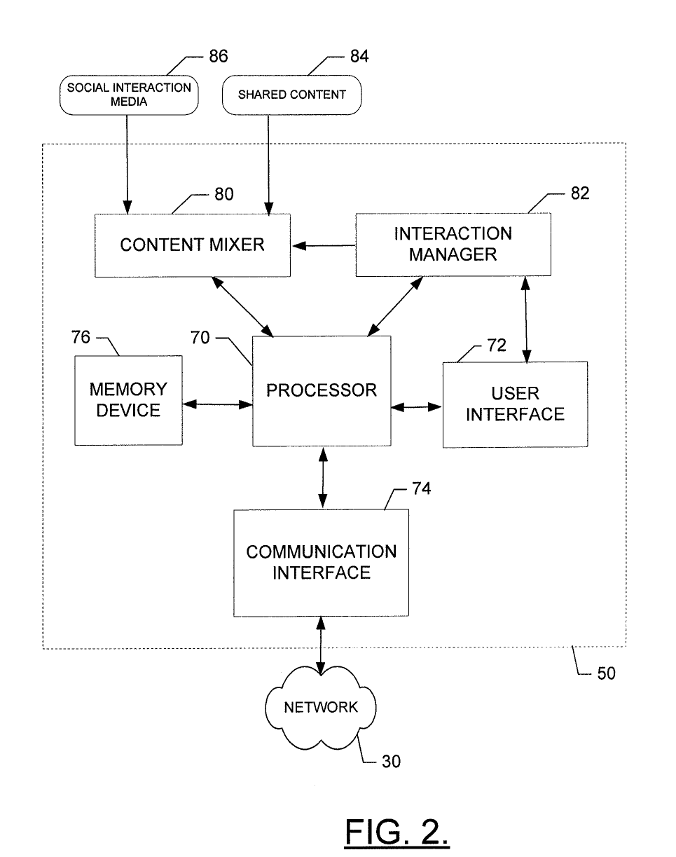

FIG. 2 illustrates a schematic block diagram of an apparatus for enabling the provision of media mixing based on user interactions according to an example embodiment of the present invention. An example embodiment of the invention will now be described with reference to FIG. 2, in which certain elements of an apparatus 50 for providing media mixing based on user interactions are displayed. The apparatus 50 of FIG. 2 may be employed, for example, on a communication device (e.g., the mobile terminal 10 and/or the second or third communication devices 20 or 25) or a variety of other devices, both mobile and fixed (such as, for example, the service platform 40 or any of the devices listed above). Alternatively, embodiments may be employed on a combination of devices. Accordingly, some embodiments of the present invention may be embodied wholly at a single device (e.g., the mobile terminal 10 or the service platform 40) or by devices in a client/server relationship. Furthermore, it should be noted that the devices or elements described below may not be mandatory and thus some may be omitted in certain embodiments.

Referring now to FIG. 2, an apparatus 50 for providing media mixing based on user interactions is provided. The apparatus 50 may include or otherwise be in communication with a processor 70, a user interface 72, a communication interface 74 and a memory device 76. The memory device 76 may include, for example, one or more volatile and/or non-volatile memories. In other words, for example, the memory device 76 may be an electronic storage device (e.g., a computer readable storage medium) comprising gates or other structure configured to store data (e.g., bits) that may be retrievable by a machine (e.g., a computing device). The memory device 76 may be configured to store information, data, applications, instructions or the like for enabling the apparatus to carry out various functions in accordance with example embodiments of the present invention. For example, the memory device 76 could be configured to buffer input data for processing by the processor 70. Additionally or alternatively, the memory device 76 could be configured to store instructions for execution by the processor 70. In some embodiments, the memory device 76 may also or alternatively store content items (e.g., media content, documents, chat content, message data, videos, music, pictures and/or the like).

The processor 70 may be embodied in a number of different ways. For example, the processor 70 may be embodied as one or more of various processing means such as a coprocessor, a microprocessor, a controller, a digital signal processor (DSP), a processing element with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, processing circuitry, or the like. In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing embodiments of the present invention by further configuration of the processor 70 by instructions for performing the algorithms and/or operations described herein. In some cases, the processor 70 may include, among other things, a clock, an arithmetic logic unit (ALU) and logic gates configured to support operation of the processor 70.

Meanwhile, the communication interface 74 may be any means such as a device or circuitry embodied in either hardware, software, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. In an example embodiment in which the apparatus is embodied as a server or some other network devices, the user interface 72 may be limited, provided remotely (e.g., from the mobile terminal 10 or another device) or eliminated. However, in an embodiment in which the apparatus is embodied as a communication device (e.g., the mobile terminal 10), the user interface 72 may include, among other devices or elements, any or all of a speaker, a microphone, a display, and a keyboard or the like. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an example embodiment, the processor 70 may be embodied as, include or otherwise control a content mixer 80 and an interaction manager 82. The content mixer 80 and the interaction manager 82 may each be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the content mixer 80 and the interaction manager 82, respectively, as described below. Thus, in examples in which software is employed, a device or circuitry (e.g., the processor 70 in one example) executing the software forms the structure associated with such means.

In an example embodiment, the content mixer 80 may be configured to combine at least two data streams into a single combined content item capable of rendering at an output device such as a display and/or speakers or other user interface components. In some cases, the content mixer 80 may be configured to overlay social interaction media 86 over audio and/or video content from the content distributor 42. As such, the content mixer 80 may combine signaling associated with the audio and/or video content, which may be content intended for sharing amongst members of a group (e.g., shared content 84), with graphics, audio, video, text, images and/or the like that may be provided by one or more group members for sharing with other group members as social interaction media 86. The combined data output from the content mixer 80 may then be provided for display and/or audio rendering such that, for example, video, images, text or graphics associated with the social interaction media 86 are overlaid over the video content of the shared content 84 and sound associated with the social interaction media 86 is dubbed into the audio of the shared content 84. In an example embodiment, the output of the content mixer 80 may also include augmentations or other modifications associated with audio encoding based on user interactions as indicated by the interaction manager 82 as described in greater detail below. As such, for example, the content mixer 80 may be configured to provide for encoding audio to be reflective of a position of a media window of a particular group member on a display or a client device. Thus, if a media window appears on the left side of the display, the corresponding audio may be encoded to provide an audio effect of originating from the user's left side.

The interaction manager 82 may be configured to, perhaps among other things, manage user input regarding intended movements of social interaction media content items with respect to the content mixer 80. Thus, for example, the interaction manager 82 is configured to enable a user to provide commands regarding movement of a media window or other social interaction media content item for movement or other size or configuration changes with respect to the media window or other social interaction media content item and process the commands for implementation of the desired effect on terminals of other group members. In an example embodiment, the interaction manager 82 may receive indications of user inputs made via the user interface 72 and provide corresponding changes to the display of a device rendering mixed content (e.g., shared content 84 with social interaction media 86 overlaid thereon). Some example indications that may be handled include movement of the location of a media window or other social interaction media content item and/or modifications to the size of the media window or other social interaction media content item.

In an example embodiment, the interaction manager 82 may also provide signaling indicative of the movement or configuration change of a media window to the content mixer 80 to enable the content mixer 80 to mix audio and providing audio encoding that is reflective of changes in configuration (e.g., changes in media window size or location). As such, for example, the interaction manager 82 may be configured to provide indications to the content mixer 80 regarding relative movement of a media window on a display rendering mixed content to enable the content mixer 80 to encode audio corresponding to the media window to be reflective of the relative movement. In other words, the interaction manager 82 may inform the content mixer 80 of the movement of a media window so that the content mixer 80 can make the audio associated with the moved media window sound like it is originating from a new location based on the movement of the media window. For example, in response to a media window being moved to the right, the corresponding audio may be encoded to sound like it is originating from the user's right side. As another example, in response to a media window being increased in size, the corresponding audio may be encoded to sound louder or more dominant with respect to mixing the corresponding audio with audio of the shared content 84 and any other social interaction media. Likewise, in response to a media window being decreased in size, the corresponding audio may be encoded to sound quieter or less dominant with respect to mixing the corresponding audio with audio of the shared content 84 and any other social interaction media.

A user may select movement of a media window, which may present live video of a present group member, by utilizing the user interface 72 to select the media window and drag the media window to another location. In some examples, the user may select a particular media window using a cursor, touch screen, gaze tracking, click and drag operation, speech, gestures or other functionality to move the media window. Indications of the movement may be provided to the content mixer 80 for providing audio mixing based on the user interaction indicated by the movement. However, as indicated above, movement is not the only alteration of the media window that may be reflected by the content mixer 80. In this regard, other configuration changes such as media window size may also impact audio mixing performed by the content mixer 80. Thus, the user may select a particular media window and increase or decrease the size of the particular media window, again using a cursor, touch screen, gaze tracking, click and drag operation, speech, gestures or other functionality to change the size of the media window.

A user may decide to move a media window for any number of reasons. In this regard, for example, the user may wish to remove an obstruction to a part of the view of the shared content 84 that is being overlaid by the media window. However, in some cases employing embodiments of the present invention, the user may also wish to achieve a desired environmental feel based on the positioning of media windows to create an impression of particular group members being located in corresponding specific positions relative to the user both visually on the display of the user's device (e.g., the mobile terminal 10) and audibly (e.g., by sound seeming to originate from a direction corresponding to the position of the respective media window on the display and having a relative volume based on the size of the media window). Movement of a media window may follow some or all of the operations in the sequence listed below in some examples with respect to the video portion of the media window:

a. The user uses a touch input (or a cursor or other input mechanism) to point at a display region (e.g., on a device display screen), the area pointed to having coordinates centered at a position (X1, Y1) and corresponding to a region in the device screen (e.g., a window of smaller size than the device display that includes the social interaction media).

b. Then the user drags the media window (e.g., including the session participant) that contains the point (X1, Y1) to a new location of the display having coordinates centered at a position (X2, Y2).

c. The screen coordinates (X1, Y1) and (X2, Y2) may optionally be converted into received video coordinates (according to the video signal received there may be need of scaling operations) (VX1, VY1) and (VX2, VY2) that are the center coordinates in the received video signal for the original and target positions in the device.

d. The received video coordinates (VX1, VY1) and (VX2, VY2) are transmitted to the content mixer 80.

e. If the video coordinates (VX1, VY1) are not within any of the other participants' media windows, then do nothing (the user is in this case trying to move part of the screen outside of the participants media window).

f. Re-encode the video content by shifting the position of the participant's media window that contains the coordinates (VX1, VY1) to a new position with center (VX2, VY2).

g. Transmit the new encoded content to all the session participants.

Further to the operations listed above, audio encoding may also be accomplished by the content mixer 80 to mix the audio content as described above. As such, the audio content may also be encoded to reflect the relative positions of the media windows on the display using coding parameters that correspond to the position of the media window on the display screen. Thus, for example, media windows on the left side of the display may be encoded to sound as though the sound originates to the user's left and media windows on the right side of the display may be encoded to sound as though the sound originates at the user's right. The amount of right or left offset may also impact the encoding to create a corresponding degree of audio offset. For example, the display could be thought to correspond to a grid-like coordinate system with horizontal coordinates from 0 (far left) to 10 (far right), with 5 corresponding to the center. Thus, a media window positioned at a horizontal coordinate of 0 would be encoded to sound as though it is originating to the far left of the user, while a media window positioned at a horizontal coordinate of 3 would still sound as though it originates to the left of the user, but not as far to the left as the sound corresponding to the media window at the horizontal coordinate of 0. In some embodiments, the user may slowly drag a media window across the screen and experience an audible movement of the origin of the sound as the media window moves.

In some examples, in addition to a horizontal scale, other encoding parameters may also be used to create vertical dimensions and even perhaps depth dimensions for three dimensional coding. As such, for example, parameters such as any or all of horizontal position, vertical position and depth position of the media window could be used for providing spatial audio mixing that is based on user interactions. Scaling operations may be provided by the content mixer 80 in some examples in order to fit the same scale to different display screen sizes.

In some embodiments, multi-party conferencing may be accomplished using a content mixer 80 in association with a conferencing mixing server. In other cases, a social TV server may be used to provide mixing of multiple media streams (from the participants as well as from the TV/Video content stream). In these and other examples, when a participant is customizing the view, instead of signaling the changes in position of the rendered media, the participant may perform a signal transformation by recording the new coordinates of the participant's window and comparing it with the original/baseline coordinates. The media transformation could use, for example, post-processing the signal to reverse the coordinate change at the receiver end, re-encoding the audio content with new parameters, and/or changing the single channels (2 or more channels) volume (remixing) in a suitable way such that it will render the audio output from the “new” position.

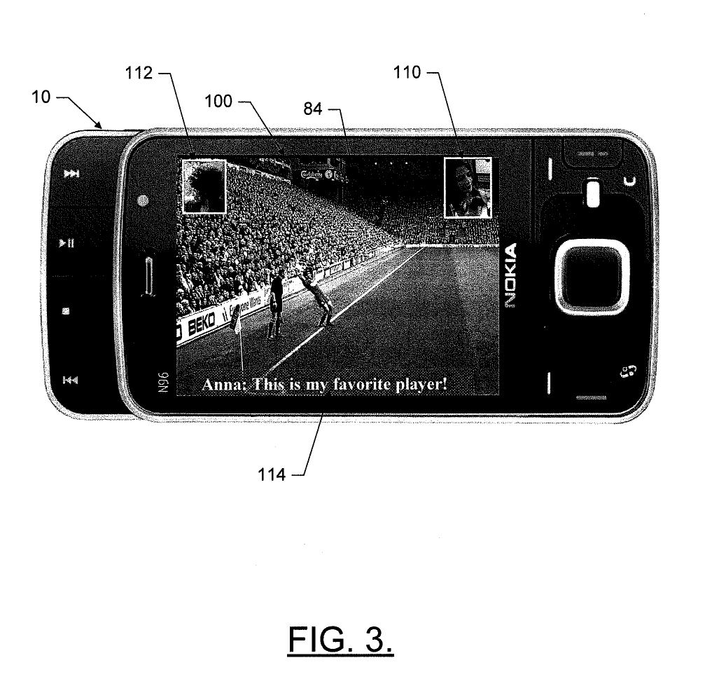

FIG. 3 illustrates a sample display view of mixed (or composite) content according to an example embodiment of the present invention. In this regard, FIG. 3 shows an example of a mobile communication device (e.g., mobile terminal 10) that may be used in connection with an example embodiment. The mobile terminal 10 includes a display 100 that is presenting shared content 84 in the form of a sporting event. The mobile terminal 10 is also displaying various content items associated with social interaction media 86. In this example, the social interaction media 86 includes a media window 110 of a first group member and a media window 112 of a second group member participating in a chat session while watching the shared content 84. The media windows 110 and 112 may be real time video feeds in some cases, but may also be static images or graphics animations stored in association with the corresponding contact information of each respective group member in other embodiments. Although two group members are shown in this example, any number of group members could be shown. Moreover, in some embodiments, media window of a group member may only be shown when a corresponding one of the group members provides social interaction media 86 or a limited number of media windows of most active or most recently active members may be provided. However, in alternative embodiments, media windows of present group members may be shown. Thus, any number of media windows for present group members (or actively chatting group members) may be provided. The social interaction media 86 of this example also includes chat text 114. The chat text 114 indicates an identity of the provider of the chat text 114 and the content itself. In some cases, chat content may be provided by users that do not wish to be seen or do not have the capability to stream real-time video of themselves to the group. The social interaction media 86 is provided as visual (and perhaps also audio) overlay content that is presented over the shared content 84. In some cases, the visual overlay content may have some degree of transparency, as in the case of the chat text 114. However, in other cases, the visual overlay content may not be transparent, as in the case of the media windows 110 and 112. In various alternatives, the media windows 110 and 112, chat text 114 and any other overlay content can be either not be transparent, or have varying degrees of transparency.

In the example of FIG. 3, the shared content 84 may be provided to the content mixer 80 along with social interaction media 84 to provide a mixed content view shown on the display 100. As shown in FIG. 3, the video of the media windows 110 and 112 is overlaid over the video of the shared content 84 and the media window 110 is positioned to the user's far left, while the media window 112 is positioned to the user's far right. Thus, the content mixer 80 may encode audio associated with media window 110 to make the corresponding speaker sound like he or she is positioned to the left of the user. Likewise, the content mixer 80 may encode audio associated with media window 112 to make the corresponding speaker sound like he or she is positioned to the right of the user.

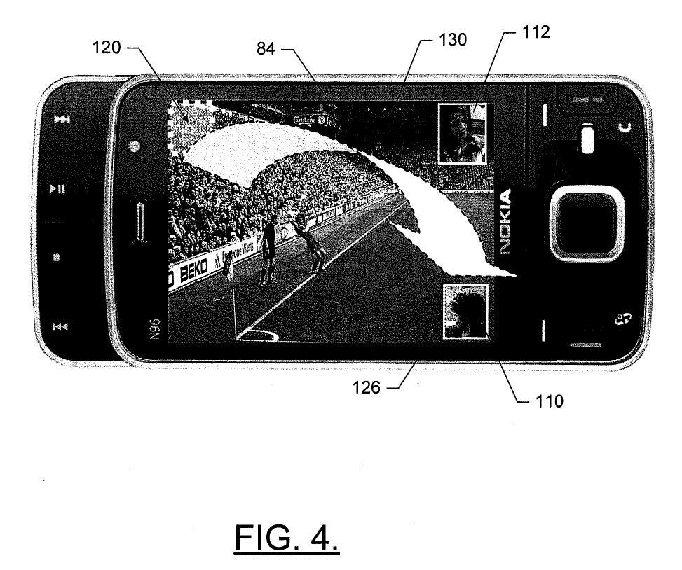

The content mixer 80 may also receive information descriptive of configuration changes with respect to the social interaction media 86 as provided by user interaction detected and reported by the interaction manager 82. FIG. 4 illustrates a sample display view of mixed content showing movement of social interaction media according to an example embodiment of the present invention. In FIG. 4, the media window 110 of the first group member is shown at an original location 120 (e.g., an original location with center point X1, Y1) in the upper left corner of a display view 130 of the shared content 84. The media window 112 of the second group member is shown in the upper right corner of the display view. In this example, the user has selected to move the media window 110 from the original location 120 to a new location 126 (e.g., a new location with center point X2, Y2) at the bottom right corner of the display view 130. In response to the selection made by the user, the content mixer 80 alters the video displayed to overlay the media window 110 at the new location 126 instead of at the original location 120. Thus, the visual overlay of the media window has shifted locations. In an example embodiment, the content mixer 80 also encodes the audio associated with the media window 110 such that the audio now sounds like it is originating from the right of the user instead of from the left of the user (as had been the case prior to the movement of the media window 110).

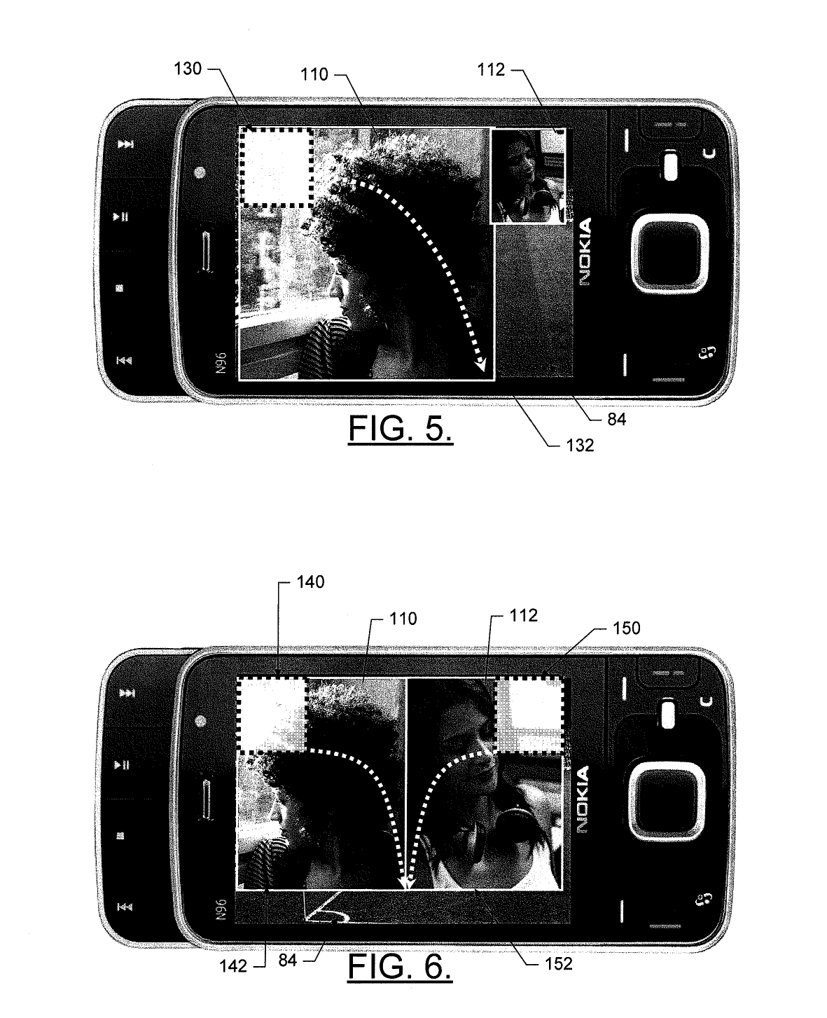

FIG. 5 illustrates another sample display view of mixed content showing a different configuration change to the social interaction media according to an example embodiment of the present invention. In FIG. 5, an original size 130 of the media window 110 of the first group member is shown relative to an expanded size 132. In this example, the user may have selected a boundary of the media window 110 and expanded the boundary to change the configuration of the media window 110 from the original size 130 to the expanded size 132. In this example, the expansion of the media window 110 to cover nearly the entire display view 130 and thereby obstruct the view of the shared content 84 (but not the view of the media window 112 of the second group member) may cause a corresponding change to the audio encoding provided by the content mixer 80. In this regard, the audio associated with media window 112 may be relatively unchanged, but the audio associated with media window 110 may now be rendered in higher volume (including much higher volume than that of the shared content). Furthermore, since the center of the media window 110 has also moved to the right, the audio associated with the media window 110 may also be encoded to sound as though it originates closer to the center rather than to the far left of the user.

FIG. 6 illustrates yet another sample display view of mixed content showing a different configuration change to the social interaction media according to an example embodiment of the present invention. In FIG. 6, an original size 140 of the media window 110 of the first group member is shown relative to an expanded size 142. In this example, the user may have selected a boundary of the media window 110 and expanded the boundary to change the configuration of the media window 110 from the original size 140 to the expanded size 142. Similarly, the user has altered the configuration of the media window 112 of the second group member such that an original size 150 of the media window 112 is shown relative to an expanded size 152. In this example, the expansion of the media windows 110 and 112 to cover nearly the entire display view 130 and thereby almost completely obstruct the view of the shared content 84 may cause a corresponding change to the audio encoding provided by the content mixer 80. In this regard, the audio associated with media window 112 may be relatively louder but shifted toward the center and the audio associated with media window 110 may now also be rendered in higher volume while being shifted toward the center. In this example, the volumes of sound associated with the media windows 110 and 112 may be approximately equal and the volume of sound associated with the shared content may be zero or almost zero.

As indicated above, the apparatus 50 may be employed at a network device (e.g., the service platform 40) or at a communication device (e.g., the mobile terminal 10). Accordingly, it should be appreciated that the mixing of content according to example embodiments could be accomplished either at the device displaying the content (such as when the mobile terminal 10 includes the apparatus 50) or at a device serving content to the device displaying the content (such as when the service platform 40 includes the apparatus 50). Thus, for example, if the apparatus 50 is employed at the device serving content to the device displaying the content, the social interaction media 86 and the shared content 84 could be provided in a single stream of data (e.g., composite or mixed data). However, if the apparatus 50 is employed at the device displaying the content, the social interaction media 86 and the shared content 84 could be provided in separate streams of data. In still another alterative embodiment, portions of the apparatus 50 may be split between multiple devices (as discussed above), and thus the content mixer 80 may be embodied at the device displaying the content (e.g., the mobile terminal 10), while the interaction manager 82 is embodied at the device serving content to the device displaying the content (e.g., at the service platform 40). In this example, the shared content 84 may be provided in one stream and the social interaction media 86 may be provided in a separate stream. Regardless of the mechanism by which the streams of data are received and where each respective device is physically located, the content mixer 80 may be configured to modify media mixing (e.g., modify the content to be displayed and the sound to be rendered) to provide media mixing based on user interaction.

In some embodiments, the content mixer 80 may also be configured to perform other functions such as providing animation functions. Thus, for example, the content mixer 80 may be configured to animate audio and video mixing in synch to provide certain desired special effects. As an example, when closing a media window, instead of the media window disappearing immediately, the content mixer 80 may be configured to gradually reduce the size of the media window and correspondingly reduce the speech volume until the window is closed and the volume is reduced to zero. Other functions may also be performed.

Accordingly, some embodiments of the present invention may provide a mechanism by which user interaction may impact media mixing. In this regard, for example, movements of media windows associated with social interaction media may have movable locations and the content mixer 80 may account for visual movement of the media window and also synchronize audio spatial changes with the corresponding location changes on the visual display. Accordingly, users may be able to experience an intuitive relationship between the location of media windows on the screen and the direction from which the corresponding audio for each media window seems to originate.

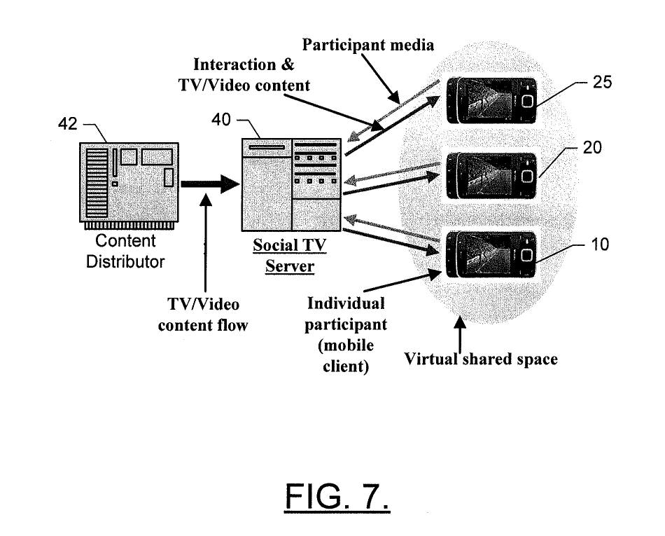

FIG. 7 shows one example structure for a system that may employ media mixing based on user interaction in accordance with example embodiments of the present invention. Although FIG. 7 is discussed in connection with social TV, it should be appreciated that embodiments of the present invention could be practiced in connection with other types of shared content as well. FIG. 7 illustrates media mixing in connection with social TV where shared content is mixed with social interaction media at a social TV server (e.g., the service platform 40) and then provided to participant client devices in a virtual shared space. As shown in FIG. 7, the interaction media streams (e.g., participant media) may be provided to the service platform 40 so that the service platform 40 can aggregate social interaction media for provision to all group members or client devices (e.g., the mobile terminal 10 and the first and second communication devices 20 and 25). The shared content and social interaction media may be mixed to provide mixed or composite content based on user interactions to move social interaction media content items on the display and alter the sound associated therewith to be reflective of the movement on the display. The mixed content may then be provided as a composite stream to each participant client device.

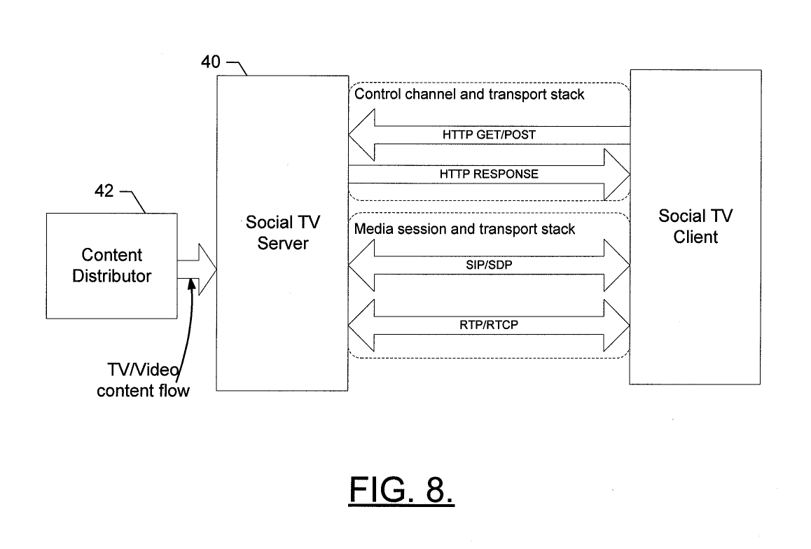

In an example embodiment, signaling of user selections (e.g., coordinate locations of media windows moved or altered in size) may be provided via a session control channel. Any suitable protocols may be employed for control channel and transport stacks and for media session and transport stacks (e.g., session initiation protocol (SIP), session description protocol (SDP), real-time transport protocol (RTP), real-time transport control protocol (RTCP), HTTP, short message service (SMS), and/or the like, as shown in FIG. 8.

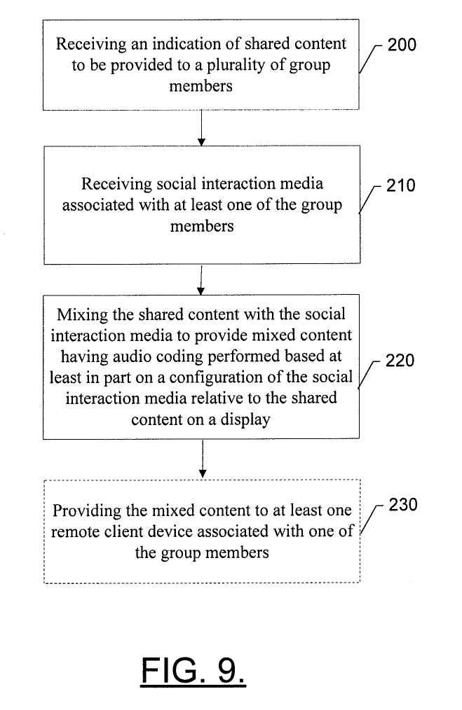

FIG. 9 is a flowchart of a method and program product according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of the mobile terminal or network device and executed by a processor in the mobile terminal or network device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture including instruction means which implement the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions, combinations of operations for performing the specified functions and program instruction means for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention, as shown in FIG. 9, may include receiving an indication of shared content to be provided to a plurality of group members at operation 200 and receiving social interaction media associated with at least one of the group members at operation 210. The method may further include mixing the shared content with the social interaction media to provide mixed content having audio mixing performed based at least in part on a configuration of the social interaction media relative to the shared content on a display at operation 220.

In some embodiments, certain ones of the operations above may be modified or further amplified as described below. Moreover, in some situations, the operations described above may be augmented with additional optional operations (an example of which is shown in FIG. 9 in dashed lines). It should be appreciated that each of the modifications, augmentations or amplifications below may be included with the operations above either alone or in combination with any others among the features described herein.

In an example embodiment, the method may further include providing the mixed content to at least one remote client device associated with one of the group members at operation 230. In some cases, mixing the shared content with the social interaction media may include performing audio mixing for a media window based on a size of the media window. For example, performing audio mixing for the media window based on the size of the media window may include controlling a volume level of audio associated with the media window in direct proportion to the size of the media window. In some embodiments, mixing the shared content with the social interaction media may include performing audio mixing for a media window based on a location of the media window on the display. For example, performing audio mixing for a media window based on a location of the media window may include generating location parameters descriptive of horizontal, vertical and depth parameters and utilizing spatial mixing to mix audio of the media window with at least one of the shared content or other media window content based on the location parameters. Moreover, in some embodiments (e.g., when some functions described above are performed by different devices rather than a single device), location parameters may be transmitted from a mobile terminal to a server or service platform. In this regard, the location parameters may be descriptive of horizontal, vertical and depth parameters along with video coordinates for old and new locations (or center locations) for a media window to be moved. In an example embodiment, mixing the shared content with the social interaction media may include tracking movement of a media window and adjusting audio mixing for the media window based on the movement of the media window.

In an example embodiment, an apparatus for performing the method of FIG. 9 above may comprise a processor (e.g., the processor 70) configured to perform some or each of the operations (200-230) described above. The processor may, for example, be configured to perform the operations (200-230) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200-230 may comprise, for example, the processor 70, or respective ones of the content mixer 80, the interaction manager 82, and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising at least one processor and at least one memory including computer program code, the at least one memory and the computer program code configured to, with the at least one processor, cause the apparatus at least to perform:
receiving an indication of shared content to be provided to a plurality of group members;
receiving social interaction media associated with at least one of the group members; and
mixing the shared content with the social interaction media to provide mixed content having audio mixing performed based at least in part on a configuration of the social interaction media relative to the shared content on a display.

2. The apparatus of claim 1, wherein the at least one memory and the computer program code are further configured to, with the at least one processor, further cause the apparatus to provide the mixed content to at least one remote client device associated with one of the group members.

3. The apparatus of claim 1, wherein the at least one memory and the computer program code are further configured to, with the at least one processor, cause the apparatus to mix the shared content with the social interaction media by performing audio mixing for a media window based on a size of the media window.

4. The apparatus of claim 3, wherein the at least one memory and the computer program code are further configured to, with the at least one processor, cause the apparatus to perform audio mixing for the media window based on the size of the media window by controlling a volume level of audio associated with the media window in direct proportion to the size of the media window.

5. The apparatus of claim 1, wherein the at least one memory and the computer program code are further configured to, with the at least one processor, cause the apparatus to mix the shared content with the social interaction media by performing audio mixing for a media window based on a location of the media window on the display.

6. The apparatus of claim 1, wherein the at least one memory and the computer program code are further configured to, with the at least one processor, cause the apparatus to perform audio mixing for a media window based on a location of the media window by generating location parameters descriptive of horizontal, vertical and depth parameters and utilizing spatial mixing to mix audio of the media window with at least one of the shared content or other media window content based on the location parameters.

7. The apparatus of claim 1, wherein the at least one memory and the computer program code are further configured to, with the at least one processor, cause the apparatus to transmit location parameters from the apparatus to a service platform, the location parameters being descriptive of at least one of video coordinates for old and new locations for a media window to be moved, horizontal, vertical or depth parameters.

8. The apparatus of claim 1, wherein the at least one memory and the computer program code are further configured to, with the at least one processor, cause the apparatus to mix the shared content with the social interaction media by tracking movement of a media window and adjusting audio mixing for the media window based on the movement of the media window.

9. The apparatus of claim 1, wherein the apparatus is embodied at a mobile terminal.

10. The apparatus of claim 1, wherein the apparatus is embodied at a network service platform.

11. A method comprising:
receiving an indication of shared content to be provided to a plurality of group members;
receiving social interaction media associated with at least one of the group members; and
mixing the shared content with the social interaction media to provide mixed content having audio mixing performed based at least in part on a configuration of the social interaction media relative to the shared content on a display.

12. The method of claim 11, further comprising providing the mixed content to at least one remote client device associated with one of the group members.

13. The method of claim 11, wherein mixing the shared content with the social interaction media comprises performing audio mixing for a media window based on a size of the media window or based on a location of the media window on the display.

14. The method of claim 13, wherein performing audio mixing for the media window based on the size of the media window comprises controlling a volume level of audio associated with the media window in direct proportion to the size of the media window.

15. The method of claim 11, further comprising transmitting location parameters to a service platform, the location parameters being descriptive of at least one of video coordinates for old and new locations for a media window to be moved, horizontal, vertical or depth parameters.

16. The method of claim 13, wherein performing audio mixing for a media window based on a location of the media window comprises generating location parameters descriptive of horizontal, vertical and depth parameters and utilizing spatial mixing to mix audio of the media window with at least one of the shared content or other media window content based on the location parameters.

17. The method of claim 11, wherein mixing the shared content with the social interaction media comprises tracking movement of a media window and adjusting audio mixing for the media window based on the movement of the media window.

18. A computer program product comprising at least one computer-readable storage medium having computer-executable program code instructions stored therein, the computer-executable program code instructions comprising:
program code instructions for receiving an indication of shared content to be provided to a plurality of group members;
program code instructions for receiving social interaction media associated with at least one of the group members; and
program code instructions for mixing the shared content with the social interaction media to provide mixed content having audio mixing performed based at least in part on a configuration of the social interaction media relative to the shared content on a display.

19. The computer program product of claim 10, wherein program code instructions for mixing the shared content with the social interaction media include instructions for performing audio mixing for a media window based on a size of the media window.

20. The computer program product of claim 15, wherein program code instructions for mixing the shared content with the social interaction media include instructions for performing audio mixing for a media window based on a location of the media window on the display or instructions for tracking movement of a media window and adjusting audio mixing for the media window based on the movement of the media window.
